(19) United States
(12) Patent Application Publication
(10) Pub. No.: US 2013/0341559 A1
(43) Pub. Date: Dec. 26, 2013

(54) COMPOSITE MATERIALS AND PROCESS FOR PRODUCTION THEREOF

(71) Applicant: BASF SE, Ludwigshafen (DE)

(72) Inventors: Arno LANGE, Bad Duerkheim (DE); Gerhard Cox, Bad Duerkheim (DE); Hannes Wolf, Ludwigshafen (DE); Szilard Csihony, Gorxheimertal (DE)

(73) Assignee: BASF SE, Ludwigshafen (DE)

(21) Appl. No.: 13/923,715

(22) Filed: Jun. 21, 2013

Related U.S. Application Data
(60) Provisional application No. 61/664,191, filed on Jun. 26, 2012.

(51) Int. Cl. H01M 4/36

(52) U.S. Cl. CPC H01M 4/364
USPC 252/182.1

(57) ABSTRACT

A process for producing a composite material comprising
a) at least one (semi)metallic phase and
b) at least one organic polymer phase,
   comprising the copolymerization of
   at least one aryloxy (semi)metallate and/or aryloxy ester of a nonmetal which forms oxo acids, the nonmetal being different than carbon and nitrogen, (compound I) with
   at least one ketone, formaldehyde and/or formaldehyde equivalent (compound II)
      in the presence of
   at least one (semi)metal compound which is not an aryloxy (semi)metallate, (compound III),
      where the weight of (semi)metal in compound III is at least 5% by weight based on the weight of compound I.

The present invention is in the field of composite materials which comprise inorganic (semi)metallic phases and either polymer phases or carbonaceous phases. Composite materials of this type are generally obtainable by reactive twin polymerization. Such composite materials can be used for production of rechargeable batteries and energy stores. The invention further relates to the use of the novel composite materials in electrodes and electrochemical cells.

WO2010/112580 discloses an electroactive material which comprises a carbon phase and at least one MOₓ phase where M is a metal or semimetal. These phases form co-continuous phase domains and are produced by twin polymerization with a subsequent calcination step. According to this document, M may be selected from B, Al, Si, Ti, Zr, Sn, Sb or mixtures thereof. Si may be up to 90 mol %, based on the total amount of M.

WO2010/112581 includes a process for producing a nanocomposite material having at least one inorganic or organometallic phase and an organic polymer phase by twin polymerization. Additionally described are nanocomposite materials having a carbon phase and at least one inorganic phase of a semimetal/metal oxide or semimetal/metal nitride. The nanocomposite materials disclosed have co-continuous phase domains. It is disclosed that the metals or semimetals may be a combination of Si with at least one further metal atom, especially Ti or Sn.

PCT/EP2012/050690 describes a process for producing a composite material having at least one oxide phase and one organic polymer phase, which is achieved by copolymerization of aryloxy (semi)metallates or aryloxy esters of nonmetals which form oxo acids with formaldehyde or formaldehyde equivalents. Calcination of the copolymer leads to electroactive nanocomposite materials comprising an inorganic phase of a semimetal/metal and a carbon phase, the phases occurring in co-continuous phase domains.

EP application no. 11181795.3 describes a process based on the reaction of tin-containing monomers by twin polymerization. The composite materials disclosed have at least one tin oxide phase and an organic polymer phase, and the phases may be present in co-continuous phase domains. This composite material can, as described in EP application no. 11181795.3, also be utilized for production of a tin-carbon composite material.

EP application no. 11178160.5 discloses an electroactive material comprising a carbon phase and at least one SnOₓ phase where x is a number from 0 to 2, by reaction of a novolac with a tin salt.

In order to be able to produce anode materials based on composite materials having nanoscale carbon- and (semi)metal-comprising phases on the industrial scale, a simple, reproducible and inexpensive production method is required. This is also true of the reactants needed therefor. In addition, it should be possible to control the properties of the composite material synthesized, especially the (semi)metal content, by a controlled modification of the process conditions and/or of the starting materials.

It was an object of the present invention to provide a composite material which is suitable as an anode material for lithium ion batteries. A process for production thereof was also to be found, which allows the composite material to be produced in a simple manner, with reproducible quality and on the industrial scale, and it was to be possible to conduct production in a reliable and inexpensive manner and with readily available starting materials. Another aim was that the (semi)metal content was to be adjustable within very wide limits.

The electrochemical cells produced with this anode material were to have a high capacity, cycling stability, efficiency and reliability, and good mechanical stability and low impedances. In addition, the process was to be employable for a multitude of combinations of different (semi)metals, which were to be usable in a flexible ratio.

This object is achieved by a process for producing a composite material comprising

a) at least one (semi)metallic phase and
b) at least one organic polymer phase,
the process comprising the copolymerization of
at least one aryloxy (semi)metallate and/or aryloxy ester of a nonmetal which forms oxo acids, the nonmetal being different than carbon and nitrogen, (compound I) with
at least one ketone, formaldehyde and/or formaldehyde equivalent (compound II) in the presence of
at least one (semi)metal compound which is not an aryloxy (semi)metallate, (compound III),
   where the weight of (semi)metal in compound III is at least 5% by weight based on the weight of compound I.

The present invention further provides a composite material comprising
a) at least one (semi)metallic phase and
b) at least one organic polymer phase,
   wherein at least one (semi)metallic phase comprises at least two different (semi)metals, the weight of each (semi)metal in the composite material is at least 2% by weight based on the weight of carbon in the composite material, at least one organic polymer phase forms phase domains with at least one (semi)metallic phase, and the average distance (the arithmetic mean of the distances) between two adjacent domains of identical phases, determined with the aid of small-angle X-ray scattering, is essentially not more than 200 nm.

The invention likewise provides a composite material (also referred to hereinafter as “electroactive material” comprising
a) at least one carbon phase and
b) at least one oxidic phase and/or (semi)metallic phase which comprises at least two different (semi)metals,
   wherein the weight of each (semi)metal in the composite material is at least 2% by weight based on the weight of carbon in the composite material, at least one oxidic phase and/or (semi)metallic phase and at least one carbon phase form phase domains, the average distance (the arithmetic mean of the distances) between two adjacent domains of identical phases, determined with the aid of small-angle X-ray scattering, is essentially not more than 10 nm and/or the oxidic and/or (semi)metallic phase forms essentially phase domains with an average diameter (the arithmetic mean of the diameters) of not more than 20 μm, determined with the aid of small-angle X-ray scattering.

Further embodiments of the present invention are the use of the inventive electroactive material as electrodes in electrochemical cells, and electrodes for electrochemical cells which comprise the inventive electroactive material. In addition, the invention provides electrochemical cells which comprise an electrode comprising the inventive electroactive material, and for the use thereof in a lithium ion battery and in a device, and devices and lithium ion batteries which comprise an inventive electrochemical cell.

### BRIEF DESCRIPTION OF THE DRAWINGS

FIG. 1 shows a TEM image of an electroactive material obtained at a higher temperature.

FIG. 2 shows a TEM image of an electroactive material obtained at a lower temperature.

FIG. 3 shows a discharge capacity of two cells over 40 cycles.

FIG. 4 shows a plot of differential capacity against the voltage.

The process according to the invention is associated with a number of advantages. Particular emphasis is given to the readily available starting materials, the variety of usable reactants and the flexibility with regard to the composite materials producible. For example, the properties of the organic polymer phase can be modified by copolymerizing different compounds I which differ in the nature of the aryloxy group. In a similar manner, it is possible to control the properties of the (semi)metallic phase by simultaneous use of compounds I comprising different (semi)metals or nonmetals, in combination with at least one compound III comprising one or more (semi)metals.

For a definition of the term “phase”, reference is made to the book A. D. McNaught and A. Wilkinson: IUPAC Compendium of Chemical Terminology, 2nd Edition, Blackwell Scientific Publications, Oxford, Version 2.3.1 (2012) 1062. Also used are the terms “phase domain” and “co-continuous”, “discontinuous” and “continuous phase domain”. The exact description thereof can be found in W. J. Work et al., Definitions of Terms Related to Polymer Blends, Composites and Multiphase Polymeric Materials (IUPAC Recommendations 2004), Pure Appl. Chem., 76 (2004) 1985-2007. For instance, a co-continuous arrangement of a two-component mixture is understood to mean a phase-separated arrangement of the two phases or components, in which within one domain of each phase all the regions of the phase domain boundary can be connected to one another by a continuous path, without the path crossing any phase boundary.

The abbreviated notation “(semi)metal” in the context of this invention represents “metal and/or semimetal”; analogously, “(semi)metallic” represents “metallic and/or semimetallic”. “Oxidic” represents a chemical unit which comprises (semi)metal and oxygen. Different binding forms, for example oxides, hydroxides or mixed forms, are possible, and the stoichiometry can also vary within wide limits. For instance, forms with a low oxygen content, for example below 10, below 7 or below 5% by weight, based on the weight of the composite material, are possible, as are forms which correspond approximately to the stoichiometric composition of defined compounds such as SnO or Fe₂O₃*H₂O, and forms with a high oxygen content, for example above 15, above 20 or above 25% by weight based on the weight of the composite material.

The terms “alkyl”, “alkenyl”, “cycloalkyl”, “alkoxy”, “cycloalkoxy” and “aryl” are collective terms for monovalent organic radicals with the definition customary therefor. The possible number of carbon atoms in a radical is typically specified by the prefix C_{f}-C_{g} where f is the minimum and g the maximum number of carbon atoms.

Alkyl is a saturated, linear or branched hydrocarbyl radical which has typically 1 to 20, frequently 1 to 10 and especially 1 to 4 carbon atoms and is, for example, methyl, ethyl, n-propyl, isopropyl, n-butyl, sec-butyl, isobutyl, tert-butyl, n-pentyl, 2-pentyl, 3-pentyl, 2-methylbutyl, 3-methylbutyl, 3-methylbut-2-yl, 2-methylbut-2-yl, 2,2-dimethylpropyl, n-Hexyl, 2-hexyl, 3-hexyl, 2-methylpentyl, 2-methylpent-3-yl, 2-methylpent-2-yl, 2-methylpent-4-yl, 3-methylpent-2-yl, 3-methylpent-3-yl, 3-methylpentyl, 2,2-dimethylbutyl, 2,2-dimethylbut-3-yl, 2,3-dimethyl-but-2-yl, 2,3-dimethylbutyl, n-heptyl, 2-methylhexyl, 2-methylhex-2-yl, 2-methylhex-3-yl, 2-methylhex-5-yl, 3-methylhex-2-yl, 3-methylhexyl, 3-methylhex-3-yl, 3-methylhex-4-yl, 2-methylhex-4-yl, 2,2-dimethylpentyl, 2,2-dimethylpent-3-yl, 2,2-dimethylpent-4-yl, 2,3-dimethylpent-2-yl, 2,3-dimethylpent-3-yl, 2,3-dimethylpent-4-yl, 2,3-dimethylpent-5-yl, 2,4-dimethylpentyl, 2,4-dimethylpent-2-yl, 2,4-dimethylpent-3-yl, 2,4-dimethylpent-4-yl, 2,4-dimethylpent-5-yl, 3,3-dimethylpentyl, 3,3-dimethylpent-2-yl, 3-ethylpentyl, 3-ethylpent-2-yl, 3-ethylpent-3-yl, 2,2,3-trimethylbutyl, 2,2,3-trimethylbut-3-yl, 2,2,3-trimethylbut-4-yl, n-octyl, 2-methylheptyl, 2-methylhept-2-yl, 2-methylhept-3-yl, 2-methylhept-4-yl, 2-methylhept-5-yl, 2-methylhept-6-yl, 2-methylhept-7-yl, 3-methylheptyl, 3-methylhept-2-yl, 3-methylhept-3-yl, 3-methylhept-4-yl, 3-methylhept-5-yl, 3-methylhept-6-yl, 3-methylhept-7-yl, 4-methylheptyl, 4-methylhept-2-yl, 4-methylhept-3-yl, 4-methylhept-4-yl, 2,2-dimethylhexyl, 2,2-dimethylhex-3-yl, 2,2-dimethylhex-4-yl, 2,2-dimethylhex-5-yl, 2,2-dimethylhex-6-yl, 2,3-dimethylhexyl, 2,3-dimethylhex-3-yl, 2,3-dimethylhex-4-yl, 2,3-dimethylhex-5-yl, 2,3-dimethylhex-6-yl, 2,4-dimethylhexyl, 2,4-dimethylhex-3-yl, 2,4-dimethylhex-4-yl, 2,4-dimethylhex-5-yl, 2,4-dimethylhex-6-yl, 2,5-dimethylhexyl, 2,5-dimethylhex-3-yl, 2,5-dimethylhex-4-yl, 2,5-dimethylhex-5-yl, 2,5-dimethylhex-6-yl, 3,3-dimethylhexyl, 3,3-dimethylhex-2-yl, 3,3-dimethylhex-4-yl, 3,3-dimethylhex-5-yl, 3,3-dimethylhex-6-yl, 3,4-dimethylhexyl, 3,4-dimethylhex-2-yl, 3,4-dimethylhex-4-yl, 3,4-dimethylhex-3-yl, 3-ethylhexyl, 3-ethylhex-2-yl, 3-ethylhex-3-yl, 3-ethylhex-4-yl, 3-ethylhex-5-yl, 3-ethyl-hex-6-yl, 2,2,3-trimethylpentyl, 2,2,3-trimethylpent-3-yl, 2,2,3-trimethylpent-4-yl, 2,2,3-trimethylpent-5-yl, 2,2,4-trimethylpentyl, 2,2,4-trimethylpent-3-yl, 2,2,4-trimethylpent-4-yl, 2,2,4-trimethylpent-5-yl, 2,3,3-trimethylpentyl, 2,3,3-trimethylpent-2-yl, 2,3,3-trimethylpent-4-yl, 2,3,3-trimethylpent-5-yl, 2,3,4-trimethylpentyl, 2,3,4-trimethylpent-3-yl, 2,3,4-trimethylpent-2-yl, 3-ethyl-2-methylpentyl, 3-ethyl-2-methylpent-2-yl, 3-ethyl-2-methylpent-3-yl, 3-ethyl-2-methylpent-4-yl, 3-ethyl-2-methylpent-5-yl, 3-ethyl-3-methylpentyl, 3-ethyl-3-methylpent-2-yl, 2,2,3,3-tetramethylbutyl, n-nonyl, 2-methylnonyl or n-decyl, 3-propylheptyl.

Alkenyl is an olefinically unsaturated, linear or branched hydrocarbyl radical which has typically 2 to 20, frequently 2 to 10 and especially 2 to 6 carbon atoms and is, for example, vinyl, 1-propenyl, 2-propenyl, 2-methyl-1-propenyl, 2-methyl-2-propenyl, 1-pentenyl, 2-pentenyl, 2-methyl-1-butenyl, 3-methyl-1-butenyl, 1-methyl-2-butenyl, 2-methyl-2-butenyl, 3-methyl-2-butenyl, 1-hexenyl, 2-hexenyl, 3-hexenyl, 2-methyl-1-pentenyl, 3-methyl-1-pentenyl, 4-methyl-1-pentenyl, 2-methyl-2-pentenyl, 3-methyl-2-pentenyl, 4-methyl-2-pentenyl, 2-methyl-3-pentenyl, 3-methyl-3-pentenyl, 4-methyl-1-pentenyl, 2-methyl-1-pentenyl, 3,3-dimethyl-2-butenyl, 2,3-dimethyl-1-butenyl, 2,3-dimethyl-2-butenyl, 3,3-dimethyl-1-butenyl, 2-ethyl-1-butenyl, 2-ethyl-2-butenyl, 1-heptenyl, 2-heptenyl, 3-heptenyl, 1-octyl, 2-octyl, 3-octyl, 4-octyl, 1-nonenyl, 2-nonenyl, 3-nonenyl, 4-nonenyl, 1-decenyl, 2-decenyl, 3-decenyl, 4-decenyl or 5-decenyl.

Alkoxy is an alkyl radical, as defined above, which is bonded via an oxygen atom, has typically 1 to 20, frequently 1 to 10 and especially 1 to 4 carbon atoms and is, for example, methoxy, ethoxy, n-propoxy, isopropoxy, n-butoxy, sec-butoxy, isobutoxy, tert-butoxy, n-pentyloxy, 2-methylbutyloxy, 3-methylbutyloxy, n-hexyloxy, n-heptyloxy, n-octyloxy, 1-methylheptyloxy, 2-methylheptyloxy, 2-ethylhexyloxy, n-nonyloxy, 1-methylnonyloxy, n-decyloxy or 3-propylheptyloxy.

Cycloalkyl is a mono-, bi- or tricyclic, saturated cycloaliphatic radical which has typically 3 to 20, frequently 3 to 10 and especially 5 or 6 carbon atoms and is, for example, cyclopropyl, cyclobutyl, cyclopentyl, cyclohexyl, cycloheptyl, cyclooctyl, bicyclo[2.2.1]hept-1-yl, bicyclo[2.2.1]hept-2-yl, bicyclo[2.2.1]hept-7-yl, bicyclo[2.2.2]octan-1-yl, bicyclo[2.2.2]octan-2-yl, 1-adamantyl or 2-adamantyl.

Cycloalkyloxy is a mono-, bi- or tricyclic, saturated cycloaliphatic radical which is bonded via an oxygen atom, has typically 3 to 20, frequently 3 to 10 and especially 5 or 6 carbon atoms and is, for example, cyclopropyloxy, cyclobutyloxy, cyclopentyloxy, cyclohexyloxy, cycloheptyloxy, cyclooctyloxy, bicyclo[2.2.1]hept-1-yloxy, bicyclo[2.2.1]hept-2-yloxy, bicyclo[2.2.1]hept-7-yloxy, bicyclo[2.2.2]octan-1-yloxy, bicyclo[2.2.2]octan-2-yloxy, 1-adamantyloxy or 2-adamantyloxy.

Aryl is an aromatic hydrocarbyl radical. The aromatic hydrocarbyl radical may bear substituents. It is preferably unsubstituted. Aryl is, for example, phenyl, 1-naphthyl or 2-naphthyl.

Aryloxy groups comprise a negatively charged oxygen atom which is obtained by deprotonation of the hydroxyl groups of aromatic monohydroxy aromatics (for example those mentioned below).

The process according to the invention comprises the copolymerization of compound I with compound II in the presence of compound III. According to the invention, compound I is at least one aryloxy (semi)metallate and/or aryloxy ester of a nonmetal which forms oxo acids, the nonmetal being different than carbon and nitrogen. “Aryloxy (semi)metallates” and “aryloxy esters” are understood to mean compounds which formally have one or more—especially 1, 2, 3, 4, 5 or 6—aryloxy groups and a metal, semimetal or nonmetal which forms oxo acids. According to the invention, the nonmetal is different than carbon and nitrogen. Each aryloxy group is bonded via the deprotonated oxygen atom to a metal, semimetal or a nonmetal which forms oxo acids and is different than carbon and nitrogen. These metal, semimetal or nonmetal atoms which form oxo acids and are different than C and N are also referred to hereinafter as central atoms. As well as the aryloxy radical(s), further groups may be bonded to the central atom(s), for example 1, 2 or 3 organic radicals selected, for example, from alkyl, alkenyl, cycloalkyl and aryl, or 1 or 2 oxygen atoms.

The compound I may have a single central atom or a plurality of central atoms and, in the case of a plurality of central atoms, have linear, branched, monocyclic or polycyclic structures. Suitable monohydroxyaromatics are in particular phenol, α-naphthol and β-naphthol, which are unsubstituted, i.e. apart from the hydroxyl group do not have any other atoms bonded to the benzene or naphthalene ring than hydrogen, or have a single substituent or a plurality of—for example 1, 2, 3 or 4—substituents other than hydrogen. These substituents are especially alkyl, cycloalkyl, alkoxy, cycloalkoxy and NRaRb groups in which Ra and Rb are each independently a hydrogen atom or an alkyl or cycloalkyl radical.

The total number of groups bonded is typically determined by the valency of the central atom, i.e. of the metal, semimetal or nonmetal, to which these groups are bonded.

Typically, the central atoms of compound I are elements other than carbon and nitrogen from the following groups of the periodic table (for the entire invention, the 2011 IUPAC convention is used):

Group 1 (from this particularly Li, Na or K), group 2 (from this particularly Mg, Ca, Sr or Ba), group 4 (from this particularly Ti or Zr), group 5 (from this particularly V), group 6 (from this particularly Cr, Mo or W), group 7 (from this particularly Mn), group 13 (from this particularly B, Al, Ga or In), group 14 (from this particularly Si, Ge, Sn or Pb), group 15 (from this particularly P, As or Sb) and group 16 (from this particularly S, Se or Te). A preferred central atom of compound I is an element other than carbon and nitrogen from groups 4, 13, 14 or 15 of the periodic table and among these particularly from the 2^{nd}, 3^{rd} and 4^{th} periods. The central atoms are more preferably selected from B, Al, Si, Sn, Ti and P.

In one embodiment of the invention, one or more aryloxy semimetallates are used as compound I, i.e. compounds of semimetals such as B or Si. In a specific embodiment of the invention, compound I comprises aryloxy semimetallates in which the semimetal is silicon to an extent of at least 90 mol %, based on the total amount of semimetal atoms.

Compounds I suitable in accordance with the invention can be described particularly by the following general formula I:

[(AryO)ₘMOₙRₚ]_{q} (I)

in which
M is a (semi)metal or a nonmetal other than carbon and nitrogen which forms oxo acids;
m is an integer and is 1, 2, 3, 4, 5 or 6,
n is an integer and is 0, 1 or 2,
p is an integer and is 0, 1, 2 or 3,
q is an integer from 1 to 20, especially an integer from 3 to 6,
   m+2n+p is an integer, is 1, 2, 3, 4, 5 or 6 and corresponds to the valency of M,
Ary is phenyl or naphthyl, where the phenyl ring or the naphthyl ring is unsubstituted or may have one or more, for example 1, 2 or 3, substituents selected from alkyl, cycloalkyl, alkoxy, cycloalkoxy and NRaRb,
   in which Rₐ and R_{b} are each independently hydrogen, alkyl or cycloalkyl;
R is hydrogen, alkyl, alkenyl, cycloalkyl or aryl, where aryl is unsubstituted or may have one or more substituents selected from alkyl, cycloalkyl, alkoxy, cycloalkoxy and NRₐR_{b},
   in which Rₐ and R_{b} are each as defined above.

When m in formula I is 2, 3, 4, 5 or 6, the Ary radicals may be the same or different, in which case different Ary may differ in the nature of the aromatic ring and/or in the nature of the substitution pattern. When p in formula I is 2 or 3, the R radicals may be the same or different.

Formula I should be understood as an empirical formula; it indicates the type and number of the structural units characteristic of the compound I, namely the central atom M and the groups bonded to the central atom, i.e. the aryloxy group AryO, oxygen atoms O and the carbon-bonded R radicals, and the number of these units. The [(AryO)ₘMOₙRₚ] units, when q is greater than 1, may form mono- or polycyclic or linear structures. In formula I, M is a metal or semimetal or a nonmetal other than carbon and nitrogen which forms oxo acids, the metals, semimetals and nonmetals generally being selected from the elements other than carbon and nitrogen from the following groups of the periodic table:

Group 1 (from this particularly Li, Na or K), group 2 (from this particularly Mg, Ca, Sr or Ba), group 4 (from this particularly Ti or Zr), group 5 (from this particularly V), group 6 (from this particularly Cr, Mo or W), group 7 (from this particularly Mn), group 13 (from this particularly B, Al, Ga or In), group 14 (from this particularly Si, Ge, Sn or Pb), group 15 (from this particularly P, As or Sb) and group 16 (from this particularly S, Se or Te). M is preferably an element selected from the elements other than carbon and nitrogen from groups 4, 13, 14 and 15 of the periodic table, especially an element of the 2^{nd}, 3^{rd} and 4^{th} periods. For M, particular preference is given to B, Al, Si, Sn, Ti and P. In a very particularly preferred embodiment of the invention, M is B or Si and especially Si.

In a preferred embodiment of the invention, p in formula I is 0, i.e. the atom M does not bear any R radicals. In a further preferred embodiment of the invention, p in formula I is 1 or 2, i.e. the atom M bears at least one R radical.

According to the invention, the process comprises the copolymerization of compound I with compound II in the presence of compound III, i.e. it is also possible to use two or more aryloxy (semi)metallates and/or aryloxy esters of a nonmetal which forms oxo acids, the nonmetal being different than carbon and nitrogen. A preferred process involves using at least two aryloxy (semi)metallates and/or aryloxy esters of a nonmetal which forms oxo acids, the nonmetal being different than carbon and nitrogen. For example, it is possible to use two or more compounds which correspond to the formula I and differ by M, Ary and/or R and/or the variables m, n, p and/or q. For instance, in at least one of the compounds of the formula I, the variable p=0 and, in at least one further compound of the formula I, the variable p may be greater than or equal to 1. Preferably, one compound of the formula I comprises, as M, B, Si, Sn, Ti or P and especially B, Si or Sn, where m is 1, 2, 3 or 4, n is 0 or 1, especially 0, p is 0 and q is 0, 1, 3 or 4. The second compound of the formula I has Si or Sn as M, where m is 2, n is 0, q is 0 and p is 1 or 2. Ary in these two compounds of the formula I may be the same or different, where Ary has the aforementioned definitions and especially the definitions specified as preferred and is especially phenyl which is unsubstituted or may have 1, 2 or 3 substituents selected from alkyl, especially C₁-C₄-alkyl, and alkoxy, especially C₁-C₄-alkoxy. R is then preferably C₁-C₆-alkyl, C₃-C₁₀-cycloalkyl or phenyl, especially C₁-C₄-alkyl, C₅-C₆-cycloalkyl or phenyl. In a further specific embodiment of the invention, one of the two compounds of the formula I comprises Si as M, m is 2 or 4, n is 0, p is 0 and q is 1, 3 or 4. The second of the two compounds with the formula I has Si as M, m is 2, n is 0 and p is 1 or 2. Ary in the two compounds of the formula I may be the same or different, where Ary has the aforementioned definitions and especially the definitions specified as preferred and is especially phenyl which is unsubstituted or may have 1, 2 or 3 substituents selected from alkyl, especially C₁-C₄-alkyl, and alkoxy, especially C₁-C₄-alkoxy. R is then preferably C₁-C₆-alkyl, C₃-C₁₀-cycloalkyl or phenyl, especially C₁-C₄-alkyl, C₅-C₆-cycloalkyl or phenyl.

The variables m, n, p, Ary and R in formula I, alone or in combination and especially in combination with one of the preferred and particularly preferred definitions of M, are preferably defined as follows:
m is an integer and is 2, 3 or 4;
n is an integer and is 0 or 1;
p is an integer and is 0, 1 or 2;
Ary is phenyl which is unsubstituted or may have 1, 2 or 3 substituents selected from alkyl, preferably C₁-C₄-alkyl, more preferably methyl, cycloalkyl, especially C₃-C₁₀-cycloalkyl, alkoxy, preferably C₁-C₄-alkoxy, more preferably methoxy, cycloalkoxy, especially C₃-C₁₀-cycloalkoxy, and NRaRb in which Ra and Rb are each independently hydrogen, alkyl, especially C₁-C₄-alkyl, preferably methyl, or cycloalkyl, especially C₃-C₁₀-cycloalkyl;
R is C₁-C₆-alkyl, C₂-C₆-alkenyl, C₃-C₁₀-cycloalkyl or phenyl, especially C₁-C₄-alkyl, C₅-C₆-cycloalkyl or phenyl.

More particularly, the variables m, n, p, Ary and R in formula I, alone or in combination and especially in combination with one of the preferred and particularly preferred definitions of M, are preferably defined as follows:
m is an integer and is 2, 3 or 4;
n is an integer and is 0;
p is an integer and is 0, 1 or 2;
Ary is phenyl which is unsubstituted or may have 1, 2 or 3 substituents selected from alkyl, especially C₁-C₄-alkyl, and alkoxy, especially C₁-C₄-alkoxy.

A preferred embodiment of the compound I is that of compounds of the formula I in which q is the number 1. Such compounds can be regarded as orthoesters of the parent oxo acid of the central atom M. In these compounds, the variables m, n, p, M, Ary and R are each as defined above and, especially alone or in combination and specifically in combination, have one of the preferred or particularly preferred definitions.

The compound I may preferably be a compound of the formula I in which M is Al, B, Si, Sn, Ti or P, m is 3 or 4, n is 0 or 1, p is 0, 1 or 2 and q is 1. Ary therein has the aforementioned definitions and especially the definitions specified as preferred and is especially phenyl which is unsubstituted or may have 1, 2 or 3 substituents selected from alkyl, especially C₁-C₄-alkyl, and alkoxy, especially C₁-C₄-alkoxy.

A very particularly preferred embodiment of the compound I is that of those compounds of the formula I in which M is B, Si or Ti, m is 3 or 4, n is 0, p is 0, 1 or 2 and q is 1. Ary therein has the aforementioned definitions and especially the definitions specified as preferred and is especially phenyl which is unsubstituted or may have 1, 2 or 3 substituents selected from alkyl, especially C₁-C₄-alkyl, and alkoxy, especially C₁-C₄-alkoxy.

A specific embodiment of the compound I is a compound of the formula I in which M is Si, m is 4, n is 0 and p is 0, 1 or 2. Ary therein has the aforementioned definitions and especially the definitions specified as preferred and is especially phenyl which is unsubstituted or may have 1, 2 or 3 substituents selected from alkyl, especially C₁-C₄-alkyl, and alkoxy, especially C₁-C₄-alkoxy.

Examples of compounds of the formula I where q=1 which are preferred in accordance with the invention are tetraphenoxysilane, tetra(4-methylphenoxy)silane, triphenyl borate, triphenyl phosphate, tetraphenyl titanate, tetracresyl titanate, tetraphenyl stannate and triphenyl aluminate.

Further embodiments of the compound I are those compounds of the general formula I in which the Ary radicals are different. As a result, the melting point of the compound I is generally lowered, which can give advantages in the polymerization. Examples of compounds of the formula I with different Ary which are preferred in accordance with the invention are triphenoxy(4-methylphenoxy)silane, diphenoxybis(4-methylphenoxy)silane, triphenoxy(4-methylphenoxy)silane, diphenoxydi(4-methylphenoxy)silane, diphenyl 4-methylphenyl borate, triphenyl 4-methylphenyl titanate and diphenyl bis(4-methylphenyl) titanate and mixtures thereof.

A further specific embodiment of the compound I is that of those compounds of the formula I in which M is Si, m is 1, 2 or 3, n is 0 and p is 4-m. Ary therein has the aforementioned definitions and especially the definitions specified as preferred and is especially phenyl which is unsubstituted or may have 1, 2 or 3 substituents selected from alkyl, especially C₁-C₄-alkyl, and alkoxy, especially C₁-C₄-alkoxy. In these compounds, R has the definitions described for formula I; more particularly, R is hydrogen, methyl, ethyl, phenyl, vinyl or allyl. Examples of preferred compounds I of this embodiment are diphenoxysilane, diphenoxymethylsilane, triphenoxysilane, methyl(triphenoxy)silane, dimethyl(diphenoxy)silane, trimethyl(phenoxy)silane, phenyl(triphenoxy)silane and diphenyl(diphenoxy)silane.

Suitable compounds I are also “condensation products” of compounds of the formula I where q=1. These compounds generally have the formula I in which q is an integer greater than 1, for example an integer in the range from 2 to 20, and especially 3, 4, 5 or 6. Such compounds derive in a formal sense through condensation of compounds of the formula I where q=1, with formal removal in each case of two AryO units to form an Ary-O-Ary molecule and an M(OAry)ₘ₋₂(O)ₙ+1Rₚ unit. They are accordingly formed essentially from the structural elements of the following formula (Ia):

-[—O-A-]- (Ia)

in which
-A- is an M(AryO)ₘ₋₂(O)ₙ(R)ₚ group where M, Ary and R are each as defined above,
m is an integer and is 3 or 4,
n is an integer and is 0 or 1 and especially 0,
p is an integer and is 0, 1 or 2,
m+2n+p is an integer, is 3, 4, 5 or 6 and corresponds to the valency of M.

Preferably, M in the formula I is Si, Sn, B and P.

In a preferred embodiment, the condensation product is cyclic and q is 3, 4 or 5. Such compounds can especially be described by the following structure:

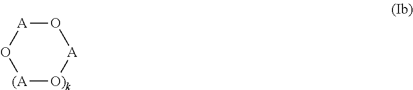

k is 1, 2 or 3 and -A- is an M(AryO)ₘ₋₂(O)ₙ(R)ₚ group. M, Ary and R each have the definitions given above for formula I and m, n and p satisfy the conditions given above in connection with formula I.

In a further preferred embodiment, the condensation product is linear and is satisfied by an AryO unit at the ends. In other words, such compounds can be described by the following structure Ic:

Ary-[—O-A-]_{q}-OAry (Ic)

q is an integer in the range from 2 to 20 and -A- is an M(AryO)ₘ₋₂(O)ₙ(R)ₚ group in which M, Ary and R are each as defined above for formula I and m, n and p are each as defined above in connection with formula I. Particular preference is given to this embodiment when compounds have a distribution in relation to the number of repeated units, i.e. have different q. For example, mixtures in which at least 99% by weight, at least 90% by weight, at least 80% by weight or at least 60% by weight, based on the mass of the compound I, are present as an oligomer mixture where q=2 to 6 or q=4 to 9 or q=6 to 15 or q=12 to 20 may be present.

Examples of such condensation products are triphenyl metaborate, hexaphenoxycyclotrisiloxane, octaphenoxycyclotetrasiloxane, triphenoxycyclotrisiloxane or tetraphenoxycyclotetrasiloxane.

The compound I is known or can be prepared in analogy to known methods for preparation of phenoxides; see, for example, DE 1816241, Z. Anorg. Allg. Chem. 551 (1987) 61-66, Z. Chem. 5 (1965) 122-130 and Houben-Weyl, volume VI-2 35-41.

According to the invention, the process comprises the copolymerization of at least one compound I with at least one compound II.

Compound II is at least one ketone, such as acetone, an aldehyde, such as furfural, or an aldehyde equivalent, such as trioxane. These compounds are generally able to form polymeric structures with phenols under condensation. In a preferred embodiment, the compound II is formaldehyde or a formaldehyde equivalent or a mixture thereof. It will be appreciated that it is also possible to copolymerize compounds of different formaldehyde equivalents. The polymerization is preferably effected using the compound II (also referred to hereinafter as formaldehyde source), which is selected from at least one gaseous formaldehyde, trioxane and/or paraformaldehyde. It is especially trioxane.

Preference is given to using the compound I and the formaldehyde or formaldehyde equivalent (compound II) in such an amount that the molar ratio of formaldehyde in compound II, i.e. the amount of monomeric formaldehyde used or the amount of formaldehyde present in the formaldehyde equivalent when a formaldehyde equivalent is used, relative to the aryloxy groups AryO present in the compound I is at least 0.7:1, better 0.9:1, preferably at least 1:1, especially at least 1.01:1, more preferably at least 1.05:1 and specifically at least 1.1:1. Greater excesses of formaldehyde are generally uncritical but unnecessary, and so formaldehyde or the formaldehyde equivalent is typically used in such an amount that the molar ratio of formaldehyde or the molar ratio of the formaldehyde present in the formaldehyde equivalent relative to the aryloxy groups AryO present in the compound I does not exceed a value of 10:1, preferably 5:1 and especially 2:1. Preference is given to using formaldehyde or the formaldehyde equivalent in such an amount that the molar ratio of formaldehyde or the molar ratio of the formaldehyde present in the formaldehyde equivalent to the aryloxy groups AryO present in the compound I is in the range from 1:1 to 10:1, especially in the range from 1.01:1 to 5:1 and specifically in the range from 1.05:1 to 5:1 or 1.1:1 to 2:1.

A formaldehyde equivalent is understood to mean a compound which releases formaldehyde under polymerization conditions. The formaldehyde equivalent is preferably an oligomer or polymer of formaldehyde, i.e. a substance with the empirical formula (CH2O)ₓ where x indicates the degree of polymerization. These include particularly trioxane (3 formaldehyde units) and paraformaldehyde, which comprises typically 8 to 100 formaldehyde units.

Compound III is at least one (semi)metal compound which is not an aryloxy (semi)metallate. The at least one (semi)metal compound may be either purely inorganic in nature, for example a halide, sulfate, nitrate or phosphate of a (semi)metal, or covalent in nature, for example an alkanoate or alkoxide of a (semi)metal.

The (semi)metal present in compound III is especially an element from group 1 (preferably particularly Na, K), group 2 (preferably particularly Ca, Mg), group 3 (preferably particularly Sc), group 4 (preferably particularly Ti, Zr), group 5 (preferably particularly V), group 6 (preferably particularly Cr, Mo, W), group 7 (preferably particularly Mn), group 8 (preferably particularly Fe, Ru, Os), group 9 (preferably particularly Co, Rh, Ir), group 10 (preferably particularly Ni, Pd, Pt), group 11 (preferably particularly Cu, Ag, Au), group 12 (preferably particularly Zn, Cd), group 13 (preferably particularly B, Al, Ga, In), group 14 (preferably particularly Si, Sn) and group 15 (preferably particularly As, Sb, Bi) of the periodic table. Preference is given to the (semi)metals Ti, V, Cr, Mo, W, Mn, Fe, Co, Ni, Cu, Zn, B, Si and/or Sn and particular preference to the (semi)metals Ti, Fe, Co, Cu, Si and/or Sn.

The inorganic (semi)metal compounds comprise (semi)metal halides, where the halides may be selected from fluoride, chloride, bromide, iodide and astatine, and mixtures and hydrates thereof. The (semi)metal halides used with preference are TiCl₄, CrCl₃, MnCl₂, FeCl₂, FeCl₃, CoCl₂, NiCl₂, ZnCl₂, CuCl₂, SnCl₂ and/or SnCl₄, especially TiCl₄, FeCl₃, CoCl₂, CuCl₂, SnCl₂ and/or SnCl₄. Further embodiments are (semi)metal sulfates, nitrates, phosphates or carbonates. “Sulfates” here generally represent oxo anions of sulfur (e.g. SO₄²⁻, SO₃²⁻, S₂O₃²⁻), “nitrates” oxo anions of nitrogen (e.g. NO₃, NO₂—), “phosphates” oxo anions of phosphorus, and “carbonates” oxo anions of carbon. Preference is given to (semi)metal sulfates or nitrates, especially Cr₂(SO₄)₃, MnSO₄, FeSO₄, Fe(NO₃)₃, Co(NO₃)₂, NiSO₄, Cu(NO₃)₂, ZnSO₄, and/or Sn(NO₃)₂.

When the compound III comprises an organo(semi)metallic compound, the anions present in the organo(semi)metallic compounds are, for example, carboxylates (preferably particularly acetate, butanoate, propanoate, palmitate, citrate, oxalate, acrylate), alkoxylates (as already described above, preferably particularly methoxylate, ethoxylate, n-propoxylate, isopropoxylate, n-butoxylate, sec-butoxylate, isobutoxylate and tert-butoxylate) and thiolates (especially methanethiolate, ethanethiolate, propanethiolate, butanethiolate). Especially carboxylates and alkoxylates are used, preferably acetate, methoxylate or ethoxylate. The organo(semi)metallic compounds used with preference are Fe(CH₃COO)₂, Zn(CH₃COO)₂, Cu(CH₃COO)₂, Si(OCH₃)₄, especially Fe(CH₃COO)₂ or Si(OCH₃)₄.

The compounds used with preference for the compound III are Fe(CH₃COO)₂, CoCl₂, CuCl₂, SnCl₂, FeCl₃, Si(OCH₃)₄, TiCl₄ and/or SnCl₄.

In the process according to the invention, the compound III is used in such an amount that the weight of the (semi)metal in the compound III is at least 5% by weight, usually more than 5% by weight, especially at least 10% by weight, preferably at least 15% by weight and more preferably at least 20% by weight, based on the weight of the compound I.

In one embodiment of the process according to the invention, the compound I can be polymerized with the formaldehyde source, compound II, in the presence of catalytic amounts of an acid. Typically, the acid is used in an amount of 0.1 to 10% by weight, especially 0.2 to 5% by weight, for example up to a maximum of 4 or 3 or 2 or 1% by weight, based on the weight of the compound I. Preferred acids are Brønsted acids, for example organic carboxylic acids such as trifluoroacetic acid, oxalic acid and lactic acid, and organic sulfonic acid. The latter are especially C₁-C₂₀-alkanesulfonic acids such as methanesulfonic acids, octanesulfonic acid, decanesulfonic acid and dodecanesulfonic acid, and haloalkanesulfonic acids such as trifluoromethanesulfonic acid. It is also possible to use benzenesulfonic acid or C₁-C₂₀-alkylbenzenesulfonic acids such as toluenesulfonic acid, nonylbenzenesulfonic acid and dodecylbenzenesulfonic acid. Likewise suitable are inorganic Brønsted acids such as HCl, H₂SO₄ or HClO₄. The Lewis acids used may preferably be particularly BF₃, BCl₃, SnCl₄, TiCl₄ and AlCl₃. It is also possible to use complex-bound Lewis acids or Lewis acids dissolved in ionic liquids.

The polymerization can also be catalyzed with bases. It is possible, for example, to use alkoxides, hydroxides, phosphates, carbonates and/or hydrogencarbonates of alkali metals and/or alkaline earth metals, and also ammonia and/or primary, secondary and/or tertiary amines, or else mixtures thereof. Examples of bases are sodium methoxide, sodium ethoxide, potassium tert-butoxide or magnesium ethoxide, NaOH, KOH, LiOH, Ca(OH)₂, Ba(OH)₂, Na₃PO₄, Na₂CO₃, K₂CO₃, Li₂CO₃, (CH₃)₃N, (C₂H₅)₃N, morpholine, dimethylaniline and piperidine. Typically, the base is used in an amount of 0.1 to 10% by weight, especially 0.2 to 5% by weight, for example up to a maximum of 4 or 3 or 2 or 1% by weight, based on the weight of the compound I.

For economic reasons, catalysts will be used only in the amount needed for catalysis, typically not more than 10% by weight, for example not more than 4 or 3 or 2 or 1% by weight, based on the weight of the compound I. (Semi)metal-containing acids and bases can also be used as compound III. In this case, they are used in the amounts specified for compound III.

The polymerization can also be initiated thermally, which means that the polymerization in this case is preferably effected without the addition of a catalytic amount of acid or base, by heating a mixture of compound I and compound II in the presence of compound III. The temperatures required for the polymerization are typically in the range from 50 to 250° C., especially in the range from 80 to 200° C. In the case of an acid- or base-catalyzed polymerization, the polymerization temperatures are typically in the range from 50 to 200° C. and especially in the range from 80 to 150° C. In the case of thermally initiated polymerization, the polymerization temperatures are typically in the range from 120 to 250° C. and especially in the range from 150 to 200° C.

The inventive polymerization can in principle be performed under a reduced pressure compared to standard pressure, for example in a vacuum, under standard pressure or under elevated pressure, for example in a pressure autoclave. In general, the polymerization is performed at a pressure in the range from 0.01 to 100 bar, preferably in the range from 0.1 to 10 bar, especially in the range from 0.5 to 5 bar or more preferably in the range from 0.7 to 2 bar.

The polymerization can in principle be performed in a batchwise and/or addition process. In the case of performance of the batchwise process, compounds I, II and III are initially charged in the desired amount in the reaction vessel and brought to the conditions required for polymerization. In the addition process, at least one of compounds I and II is supplied at least partly in the course of the polymerization until the desired ratio of compound I to compound II has been attained. In this case, compound III may be initially charged and/or added in the course of the polymerization. The addition may be followed by a continued reaction phase.

Preference is given to performing the batchwise process. It has been found to be advantageous to perform the polymerization in one stage, which means that the polymerization is conducted as a batch with the entire amount of compounds I, II and III, or an addition process is employed, in which the compounds I and II are added in such a way that the polymerization conditions are not interrupted until the entire amount of compounds I and II has been added to the reaction vessel. Compound III may be initially charged and/or supplied in the course of the polymerization.

The polymerization of compounds I and II in the presence of compound III can in principle be performed in any desired manner, provided that it is ensured that the components can react with one another. The reaction can accordingly be performed in bulk, for example in a melt, or in the presence of a reaction medium, especially of a solvent.

Useful solvents in principle include all solvents in which compound III is at least partly in dissolved form. This is understood to mean that the solubility of compound III in the solvent under polymerization conditions is at least 50 g/l, especially at least 100 g/l. In general, the solvent is selected such that the solubility of compound III at standard pressure and 20° C. is 50 WI, especially at least 100 WI. More particularly, the solvent is selected such that compound III is substantially or fully soluble, i.e. the ratio of solvent to compound III is selected such that, under polymerization conditions, at least 80% by weight, especially at least 90% by weight, based on the weight of compound III, or the complete amount of compound III used, is in dissolved form.

In a preferred variant, the polymerization is performed in a solvent, in which case at least 60% by weight, preferably at least 75% by weight, more preferably at least 90% by weight and most preferably at least 95% by weight of the total amount of compounds I, II and III is in dissolved form.

Preferred solvents are alcohols, ethers and ketones, especially alcohols, ethers and ketones having 1 to 8 carbon atoms. Examples of suitable alcohols are methanol, ethanol, n- and isopropanol, n-, sec-, iso- and tert-butanol, a pentanol and a hexanol. Also suitable are both cyclic (preferably particularly dioxane, tetrahydrofuran) and acyclic ethers such as methyl ethyl ether, dimethyl ether, diethyl ether, methyl tert-butyl ether, diisopropyl ether and di-n-butyl ether. Examples of suitable cyclic or acyclic ketones are acetone, butanone or cyclohexanone. Particularly preferred solvents are THF and ethanol.

Preference is given to performing the polymerization of compounds I and II in the presence of compound III in the substantial absence of water, which means that the concentration of water on commencement of the polymerization is less than 1% by weight, preferably less than 0.5% by weight and more preferably less than 0.1% by weight, based on the total weight of compounds I, II and III. The polymerization more preferably takes place with exclusion of water, i.e. under anhydrous conditions.

For production of particulate composite materials, it has been found to be useful to perform the reaction of compound I with compound II in the presence of compound III in an inert diluent. Preferred inert diluents are those which consist to an extent of at least 80% by volume, especially to an extent of at least 90% by volume and specifically to an extent of at least 99% by volume or 100% by volume, based on the total amount of diluent, of the aforementioned hydrocarbons, aromatic hydrocarbons such as mono- or poly-C₁-C₄-alkyl-substituted benzene or naphthalene, preferably particularly toluene, xylene, cumene or mesitylene, or C₁-C₄-alkyl-naphthalenes, and also aliphatic and cycloaliphatic hydrocarbons such as hexane, cyclohexane, heptane, cycloheptane, octane and isomers thereof, nonane and isomers thereof, decane and isomers thereof, and mixtures thereof.

Polymerization of compound I with compound II in the presence of compound III may be followed by purification steps and optionally drying steps. In one process variant, the composition of the inorganic phase is altered. It is possible, for example, to reduce the content of anions which originate from compound III by a washing and/or purification step. For this purpose, it is advantageously possible to use bases, for example alkoxides, hydroxides, phosphates, carbonates and/or hydrogencarbonates of alkali metals and/or alkaline earth metals, and also ammonia and/or primary, secondary and/or tertiary amines, or else mixtures thereof. Examples of bases are sodium methoxide, sodium ethoxide, potassium tert-butoxide or magnesium ethoxide, NaOH, KOH, LiOH, Ca(OH)₂, Ba(OH)2, Na₃PO₄, Na₂CO₃, K₂CO₃, Li₂CO₃, NaHCO₃, KHCO₃, (CH₃)₃N, (C₂H₅)₃N, morpholine, dimethylaniline and piperidine. These bases can also be employed in a solvent such as water, alcohols or ethers, or mixtures thereof, for example in methanol, ethanol, isopropanol, diethyl ether or THF.

In addition, the composite material obtained by the process according to the invention can be heated. This is generally executed at temperatures in the range from 200 to 2000° C., preferably in the range from 300 to 1600° C., more preferably in the range from 400 to 1100° C. and most preferably in the range from 500 to 900° C.

In one embodiment, carbonization is effected at temperatures in the lower range, for example below 600° C., below 500° C. or, for example, from 380 to 400° C. With this procedure, it is possible to obtain broad areas of the co-continuous structures. In a further embodiment, carbonization is effected at temperatures in the higher range, for example above 700° C., above 800° C. or, for example, from 950 to 1050° C. With this procedure, it is possible to produce isolated metal domains in a carbon matrix in broad areas, in which case it is advantageously possible to use reducing gases.

The duration of heating is variable and depends upon factors including the temperature to which heating is effected. The duration is, for example, between 0.5 and 50 h, preferably between 1 and 24 h, especially between 2 and 12 h.

The heating can be performed in one or more stages, for example one or two stages. In many cases, heating is effected at a rate of 1° to 10° C./min, preferably 2° to 6° C./min, i.e., for example, at 2°, 3° or 4° C./min, up to the desired temperature. The cooling may commence immediately after the attainment of this temperature, or this temperature can be maintained for 10 min to 10 h. This hold time may last, for example, for 0.5 h, 1 h, 2 h, 3 h, 4 h or 5 h. Prior to the carbonization process, it is also possible to insert a heat treatment step. This can be effected by keeping the temperature constant (for example approx. 200° C. or approx. 250° C.) within a temperature range from 100° C. to 400° C., preferably 150° C. to 300° C., until the heat treatment step is complete, i.e., for example, for 1 h or 2 h. It is additionally possible to lower the heating rates within the temperature range from 100° C. to 400° C., preferably 150° C. to 300° C., for example to ½ or ⅓ of the heating rate selected on commencement of heating.

The heating can be performed with substantial or complete exclusion of oxygen, preferably in the presence of inert gases and/or reducing gases (reactive gases). In this case, the organic polymeric material formed in the polymerization is carbonized to give the carbon phase and electroactive material is formed. In a preferred embodiment of the process according to the invention, the polymerization is performed in one stage, with substantial or complete, preferably complete, exclusion of oxygen at standard pressure. Complete exclusion of oxygen in this context means that, in the gas space in which the polymerization takes place, not more than 0.5% by volume, preferably less than 0.05% by volume and especially less than 0.01% by volume of oxygen, based on the gas space mentioned, is present. In a multistage heating process, the steps can be performed in the presence of different gases and/or at different temperatures. For example, it is first possible to heat, for example in a first step, in the presence of an inert gas such as argon or nitrogen, and then to heat, for example in a second step, in the presence of a reducing gas (reactive gas) such as Ar, N₂, H₂, NH₃, CO and C₂H₂ and mixtures thereof, for example synthesis gas (CO/H₂) and forming gas (N₂/H₂ and/or Ar/H₂).

The polymerization of compound I with compound II in the presence of compound III may also be followed by an oxidative removal of the organic polymer phase, such that the organic polymeric material formed in the polymerization of the organic constituents is oxidized to obtain a nanoporous oxidic material. In this case, the heating is performed under oxygen, in a preferred form in the presence of inert gases. In a multistage heating process, it is possible, for example, to perform the steps in the presence of different gases and/or else at different temperatures. For example, it is first possible, for example in a first step, to heat in the presence of an inert gas such as argon or nitrogen and then, for example in a second step, to heat in the presence of an oxidizing gas such as O₂, and mixtures thereof, for example air or synthetic air.

The heating of the composite material obtained by the polymerization can in principle be executed under reduced pressure, for example in a vacuum, under standard pressure or under elevated pressure, for example in a pressure autoclave. In general, the heating is performed at a pressure in the range from 0.01 to 100 bar, preferably in the range from 0.1 to 10 bar, especially in the range from 0.5 to 5 bar or 0.7 to 2 bar. The heating can be effected in a closed system or in an open system in which volatile constituents formed are removed in a gas stream which preferably comprises at least one inert gas and/or reducing gas.

More particularly, the process according to the invention is suitable for producing electroactive material in continuous and/or batchwise mode. In batchwise mode, this means batch sizes exceeding 10 kg, preferably larger than 100 kg, especially preferably larger than 1000 kg or larger than 5000 kg. In continuous mode, this means production volumes exceeding 100 kg/day, preferably exceeding 1000 kg/day, more preferably exceeding 10 t/day or exceeding 100 t/day.

Additionally disclosed herein is a composite material (K1) which can be produced, for example, by the process according to the invention and which comprises
a) at least one (semi)metallic phase and
b) at least one organic polymer phase,
   wherein the content of each (semi)metal in the composite material (K1) is at least 2% by weight based on the carbon content of the composite material (K1) and at least one organic polymer phase forms phase domains with at least one (semi)metallic phase, where the average distance (the arithmetic mean of the distances), determined with the aid of small-angle X-ray scattering, between two adjacent domains of identical phases is essentially not more than 200 nm. In a preferred embodiment, the at least one (semi)metallic phase comprises at least two different (semi)metals.

“Identical phases” mean firstly exclusively organic polymer phases, and secondly exclusively (semi)metallic phases. Adjacent phase domains of identical phases are understood to mean two phase domains of an identical phase divided by one phase domain of the other phase, preferably particularly two phase domains of the (semi)metallic phase divided by one phase domain of the organic polymer phase, or two phase domains of the polymer phase divided by one phase domain of the (semi)metallic phase.

The average distance between adjacent phase domains of identical phases is typically not more than 200 nm, frequently not more than 100 nm or not more than 50 nm, and especially not more than 10 nm or not more than 5 nm. The average distance between the domains of adjacent identical phases can be determined by means of small-angle X-ray scattering (SAXS) via the scatter vector q (measurement in transmission at 20° C., monochromatized CuK radiation, 2D detector (image plate), slit collimation). The size of the phase regions and hence the distances between adjacent phase boundaries and the arrangement of the phases can also be determined by means of transmission electron microscopy (TEM), especially by means of HAADF-STEM (high angle annular darkfield scanning electron microscopy) methodology.

The (semi)metallic phase may in principle comprise any element which forms oxidic structures. Preference is given to the oxides of (semi)metals, particular preference to the elements of group 1 (preferably particularly Na, K), group 2 (preferably particularly Ca, Mg), group 3 (preferably particularly Sc), group 4 (preferably particularly Ti, Zr), group 5 (preferably particularly V), 6 (preferably particularly Cr, Mo, W), group 7 (preferably particularly Mn), group 8 (preferably particularly Fe, Ru, Os), group 9 (preferably particularly Co, Rh, Ir), group 10 (preferably particularly Ni, Pd, Pt), group 11 (preferably particularly Cu, Ag, Au), group 12 (preferably particularly Zn, Cd), group 13 (preferably particularly B, Al, Ga, In), group 14 (preferably particularly Si, Sn) and group 15 (preferably particularly As, Sb, Bi) of the periodic table. Among these, preference is given to the (semi)metals Ti, V, Cr, Mo, W, Mn, Fe, Co, Ni, Cu, Zn, B, Si and Sn and particular preference to the (semi)metals Ti, Fe, Co, Cu, Si and Sn.

The content of each (semi)metal in the inventive composite material (K1) is at least 2% by weight, preferably at least 3% by weight and more preferably at least 5% by weight, based on the carbon content of the composite material.

In the inventive composite material (K1), the areas in which co-continuous phase domains occur make up preferably at least 10% by volume, more preferably at least 30% by volume, even more preferably at least 50% by volume, exceptionally preferably at least 70% by volume, especially at least 80% by volume up to a maximum of 100% by volume, of the composite material.

The inventive composite material (K1) can easily be processed further to give the inventive electroactive material, which can be used especially for electrodes of electrochemical cells. The invention likewise provides a composite material (electroactive material) which comprises
a) at least one carbon phase and
b) at least one oxidic and/or (semi)metallic phase,
   wherein the weight of each (semi)metal in the electroactive material is at least 2% by weight based on the weight of carbon in the electroactive material, at least one oxidic and/or (semi)metallic phase and at least one carbon phase form phase domains, the average distance (the arithmetic mean of the distances) between two adjacent domains of identical phases, determined with the aid of small-angle X-ray scattering, is essentially not more than 10 nm and/or the at least one oxidic and/or (semi)metallic phase forms phase domains with an average diameter (arithmetic mean of the diameters) of not more than 20 μm, determined with the aid of small-angle X-ray scattering. In a preferred embodiment, the at least one oxidic and/or (semi)metallic phase comprises at least two different (semi)metals.

“Identical phases” mean firstly exclusively carbon phases, and secondly exclusively oxidic and/or (semi)metallic phases. Adjacent phase domains of identical phases are understood to mean two phase domains of an identical phase divided by one phase domain of the other phase, preferably particularly two phase domains of carbon phases divided by one phase domain of an oxidic and/or (semi)metallic phase, or two phase domains of oxidic and/or (semi)metallic phases divided by one phase domain of the carbon phase. The average distance between adjacent phase domains of identical phases is typically not more than 10 nm, frequently not more than 7 nm, especially not more than 5 nm and preferably not more than 3 nm. The oxidic and/or (semi)metallic phase domains typically have an average diameter of not more than 20 μm, preferably of not more than 2 μm, even more preferably not more than 500 nm, especially not more than 100 nm.

The average distance between the domains of adjacent identical phases and the average diameter of the at least one oxidic and/or (semi)metallic phase can be determined by means of HAADF-STEM or with the aid of small-angle X-ray scattering via the scatter vector q (measurement in transmission at 20° C., monochromatized CuK radiation, 2D detector (image plate), slit collimation).

In the inventive electroactive material, the ranges in which co-continuous phase domains occur make up preferably at least 10% by volume, more preferably at least 30% by volume, even more preferably at least 50% by volume, exceptionally preferably at least 70% by volume, especially at least 80% by volume to 100% by volume, based on the total volume of the electroactive material.

The at least one oxidic and/or (semi)metallic phase may in principle, for the oxidic phase, comprise any element which forms oxides. For the at least one oxidic and/or (semi)metallic phase, preference is given to oxides of (semi)metals and/or (semi)metals, more preferably the oxides of the (semi)metals and/or the (semi)metals of the elements of group 1 (preferably particularly Na, K), group 2 (preferably particularly Ca, Mg), group 3 (preferably particularly Sc), group 4 (preferably particularly Ti, Zr), group 5 (preferably particularly V), group 6 (preferably particularly Cr, Mo, W), group 7 (preferably particularly Mn), group 8 (preferably particularly Fe, Ru, Os), group 9 (preferably particularly Co, Rh, Ir), group 10 (preferably particularly Ni, Pd, Pt), group 11 (preferably particularly Cu, Ag, Au), group 12 (preferably particularly Zn, Cd), group 13 (preferably particularly B, Al, Ga, In), group 14 (preferably particularly Si, Sn) and group 15 (preferably particularly As, Sb, Bi) of the periodic table. Among these, preference is given to the (semi)metals Ti, V, Cr, Mo, W, Mn, Fe, Co, Ni, Cu, Zn, B, Si and Sn, and particular preference to the (semi)metals Ti, Fe, Co, Cu, Si and Sn.

In the at least one carbon phase, the carbon is present essentially in elemental form, i.e. the proportion of non-carbon atoms in the phase, for example N, O, S, P and/or H, is less than 10% by weight, especially less than 5% by weight, based on the total amount of carbon in the phase. The content of the non-carbon atoms in the phase can be determined by means of X-ray photoelectron spectroscopy (X-ray PES). As well as carbon, the carbon phase, as a result of the preparation, may especially comprise small amounts of N, O and/or H. The molar ratio of H to C will generally not exceed a value of 1:2, especially a value of 1:3 and specifically a value of 1:4. The value may also be 0 or virtually 0, for example less than or equal to 0.1.

In the carbon phase, the carbon is probably present predominantly in amorphous or graphitic form, as can be concluded from X-ray PES studies on the basis of the characteristic binding energy (284.5 eV) and the characteristic asymmetric signal shape. Carbon in graphitic form is understood to mean that the carbon is present at least partly in a hexagonal layer arrangement typical of graphite, in which the layers may also be curved or exfoliated.

The content of each (semi)metal in the inventive electroactive material comprising at least one carbon phase is at least 2% by weight, preferably at least 3% by weight and more preferably at least 5% by weight, based on the weight of carbon in the composite material.

Both the inventive composite material (K1) and the inventive electroactive material have the advantage that they can be produced in a simple manner, with reproducible quality and on the industrial scale, with implementability of production in a reliable and inexpensive manner and with readily available starting materials.

The present invention further provides for the use of the inventive electroactive material as part of an electrode for an electrochemical cell, and an electrode (also referred to hereinafter as anode) for an electrochemical cell which comprises the inventive electroactive material.

Due to its composition and the specific arrangement of the at least one carbon phase (a) and of the at least one oxidic and/or (semi)metallic phase (b), the inventive electroactive material is particularly suitable as a material for anodes in lithium ion cells, especially in lithium ion secondary cells or batteries. Particularly in the case of use in anodes of lithium ion cells and especially of lithium ion secondary cells, it is notable for high capacity and good cycling stability, and ensures low impedances in the cell. In addition, probably due to the specific phase arrangement, it has a high mechanical stability. Moreover, it can be produced in a simple manner and with reproducible quality from readily available starting materials.

In addition to the inventive electroactive material, the anode generally comprises at least one suitable binder for consolidation of the inventive electroactive material, and optionally further electrically conductive or electroactive constituents. In addition, the anode generally has electrical contacts for supply and removal of charges. The amount of inventive electroactive material, based on the total mass of the anode material, minus any current collectors and electrical contacts, is generally at least 40% by weight, frequently at least 50% by weight and especially at least 60% by weight.

Useful further electrically conductive or electroactive constituents in the inventive anodes include carbon black (conductive black), graphite, carbon fibers, carbon nanofibers, carbon nanotubes or electrically conductive polymers. Typically about 2.5 to 40% by weight of the conductive material are used in the anode together with 50 to 97.5% by weight, frequently with 60 to 95% by weight, of the inventive electroactive material, the figures in percent by weight being based on the total mass of the anode material, minus any current collector and electrical contacts.

Useful binders for the production of an anode using the inventive electroactive materials include especially the following polymeric materials:

polyethylene oxide, cellulose, carboxymethylcellulose, polyvinyl alcohol, polyvinylidene fluoride, polyethylene, polypropylene, polytetrafluoroethylene, polyacrylonitrile-methyl methacrylate copolymers, styrene-butadiene copolymers, tetrafluoroethylene-hexafluoropropylene copolymers, vinylidene fluoride-hexafluoropropylene copolymers, vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partly neutralized with alkali metal salt or ammonia, ethylene-methacrylic acid copolymers, optionally at least partially neutralized with alkali metal salt or ammonia, ethylene-(meth)acrylic ester copolymers, polyimides and/or polyisobutene, and mixtures thereof.

The selection of the binder is often made with consideration of the properties of any solvent used for production. For example, polyvinylidene fluorides are suitable when N-ethyl-2-pyrrolidone is used as the solvent. The binder is generally used in an amount of 1 to 10% by weight, based on the total mass of the anode material. Preference is given to using 2 to 8% by weight, especially 3 to 7% by weight.

The inventive electrode comprising the inventive electroactive material, also referred to above as anode, generally comprises electrical contacts for supply and removal of charges, for example an output conductor, which may be configured in the form of a metal wire, metal grid, metal mesh, expanded metal, a metal foil and/or a metal sheet. Suitable metal foils are especially copper foils.

In one embodiment of the present invention, the anode has a thickness in the range from 15 to 200 μm, preferably from 30 to 100 μm, based on the thickness excluding output conductor.

The anode can be produced in a manner customary per se by standard methods as known from relevant monographs. For example, the anode can be produced by mixing the inventive electroactive material, optionally using an organic solvent (for example N-methylpyrrolidinone, N-ethyl-2-pyrrolidone or a hydrocarbon solvent), with the optional further constituents of the anode material (electrically conductive constituents and/or organic binder), and optionally subjecting it to a shaping process or applying it to an inert metal foil, for example Cu foil. This is optionally followed by drying. This is done, for example, using a temperature of 80 to 150° C. The drying operation can also take place under reduced pressure and lasts generally for 3 to 48 hours. Optionally, it is also possible to employ a melting or sintering process for the shaping.

The present invention further provides an electrochemical cell, especially a lithium ion secondary cell, comprising at least one electrode which has been produced from or using an electrode material as described above.

Such cells generally have at least one inventive anode, a cathode, especially a cathode suitable for lithium ion cells, an electrolyte and optionally a separator.

With regard to suitable cathode materials, suitable electrolytes, suitable separators and possible arrangements, reference is made to the relevant prior art (see, for example, Wakihara et al.: Lithium Ion Batteries, 1st edition, Wiley VCH, Weinheim (1998); David Linden: Handbook of Batteries, 3rd edition, McGraw-Hill Professional, New York (2008); J. O. Besenhard: Handbook of Battery Materials, Wiley-VCH (1998)).

Useful cathodes include especially those cathodes in which the cathode material comprises lithium transition metal oxide, e.g. lithium cobalt oxide, lithium nickel oxide, lithium cobalt nickel oxide, lithium manganese oxide (spinel), lithium nickel cobalt aluminum oxide, lithium nickel cobalt manganese oxide or lithium vanadium oxide, or a lithium transition metal phosphate such as lithium iron phosphate. If the intention, however, is to use those cathode materials which comprise sulfur and polymers comprising polysulfide bridges, it has to be ensured that the anode is charged with Li⁰ before such an electrochemical cell can be discharged and recharged.

The two electrodes, i.e. the anode and the cathode, are connected to one another using a liquid or else solid electrolyte. Useful liquid electrolytes include especially nonaqueous solutions (water content generally less than 20 ppm) of lithium salts and molten Li salts, for example solutions of lithium hexafluorophosphate, lithium perchlorate, lithium hexafluoroarsenate, lithium trifluoromethylsulfonate, lithium bis(trifluoromethylsulfonyl)imide or lithium tetrafluoroborate, especially lithium hexafluorophosphate or lithium tetrafluoroborate, in suitable aprotic solvents such as ethylene carbonate, propylene carbonate and mixtures thereof with one or more of the following solvents: dimethyl carbonate, ethyl methyl carbonate, diethyl carbonate, dimethoxyethane, methyl propionate, ethyl propionate, butyrolactone, acetonitrile, ethyl acetate, methyl acetate, toluene and xylene, especially in a mixture of ethylene carbonate and diethyl carbonate. The solid electrolytes used may, for example, be ionically conductive polymers.

A separator impregnated with the liquid electrolyte may be arranged between the electrodes. Examples of separators are especially glass fiber nonwovens and porous organic polymer films, such as porous films of polyethylene, polypropylene etc.

Particularly suitable materials for separators are polyolefins, especially porous polyethylene films and porous polypropylene films.

Polyolefin separators, especially composed of polyethylene or polypropylene, may have a porosity in the range from 35 to 45%. Suitable pore diameters are, for example, in the range from 30 to 500 nm.

In another embodiment of the present invention, separators composed of polyethylene terephthalate nonwovens filled with inorganic particles may be present. Such separators may have a porosity in the range from 40 to 55%. Suitable pore diameters are, for example, in the range from 80 to 750 nm.

Inventive electrochemical cells further comprise a housing which may be of any shape, for example cuboidal, or the shape of a cylinder. In another embodiment, inventive electrochemical cells have the shape of a prism. In one variant, the housing used is a metal-plastic composite film elaborated as a pouch.

The cells may have, for example, a prismatic thin film structure, in which a solid thin film electrolyte is arranged between a film which constitutes an anode and a film which constitutes a cathode. A central cathode output conductor is arranged between each of the cathode films in order to form a double-faced cell configuration. In another embodiment, a single-faced cell configuration can be used, in which a single cathode output conductor is assigned to a single anode/separator/cathode element combination. In this configuration, an insulation film is typically arranged between individual anode/separator/cathode/output conductor element combinations.

The inventive electrochemical cells have high capacity, cycling stability, efficiency and reliability, good mechanical stability and low impedances.

The inventive electrochemical cells can be combined to form lithium ion batteries.

Accordingly, the present invention further also provides for the use of inventive electrochemical cells as described above in lithium ion batteries.

The present invention further provides lithium ion batteries comprising at least one inventive electrochemical cell as described above. Inventive electrochemical cells can be combined with one another in inventive lithium ion batteries, for example in series connection or in parallel connection. Series connection is preferred.

Inventive electrochemical cells are notable for particularly high capacities, high power even after repeated charging, and significantly delayed cell death. Inventive electrochemical cells are very suitable for use in devices. The use of inventive electrochemical cells in devices also forms part of the subject matter of the present invention. Devices may be stationary or mobile devices. Mobile devices are, for example, vehicles which are used on land (preferably particularly automobiles and bicycles/tricycles), in the air (preferably particularly aircraft) and in water (preferably particularly ships and boats). In addition, mobile devices are also mobile appliances, for example cellphones, laptops, digital cameras, implanted medical appliances and power tools, especially from the construction sector, for example drills, battery-powered screwdrivers and battery-powered tackers. Stationary devices are, for example, stationary energy stores, for example for wind and solar energy, and stationary electrical devices. Such uses form a further part of the subject matter of the present invention.

The use of inventive lithium ion batteries in devices, for example in appliances, offers the advantage of a longer runtime prior to recharging and of a smaller loss of capacity in the course of prolonged runtime. If an equal runtime were to be achieved with electrochemical cells having lower energy density, a higher weight would have to be accepted for electrochemical cells. Moreover, the inventive lithium ion batteries can be used as small and lightweight batteries. The inventive lithium ion batteries are also notable for high capacity and cycling stability, and they have a high reliability and efficiency as a result of a low thermal sensitivity and self-discharge rate. In addition, the lithium ion batteries can be used safely and produced inexpensively. Moreover, the inventive lithium ion batteries exhibit advantageous electrokinetic properties, which is of particular benefit in the case of vehicles with electrical drive and hybrid vehicles.

The invention is illustrated by the examples which follow, but these do not restrict the invention.

### PRODUCTION EXAMPLE 1

### 1a) Production of a Composite Material (K1.1)

50 g of tetraphenoxysilane and 16.5 g of trioxane were initially charged and melted at 70° C. Then 28.5 g of SnCl₂ were dissolved in 70 ml of THF and homogenized with the melt. This solution was added dropwise to a mixture of 200 ml of xylene and 2.5 g of methanesulfonic acid at 100° C. A white solid precipitated out, which was collected and washed with toluene and hexane. After drying, 40 g of white powder were obtained. It was treated with sodium hydrogencarbonate solution, water and methanol, and then dried.

Final weight: 35.3 g

| Elemental analysis | C | H | Si | Cl | Sn |
|---|---|---|---|---|---|
| Found | 54.4 | 4.7 | 9.1 | 0.039 | 4.3 |
| (% by weight) | | | | | |

### 1b) Production of an Electroactive Material (Higher Temperature)

6 g of composite material (K1.1) were heated in a tubular furnace with a quartz glass tube under hydrogen at a flow rate of 2-3 l/h. The oven was heated to 800° C. at 3-4° C./min and held at 800° C. for 2 h. Cooling was effected overnight under a nitrogen stream of 1-2 l/h.

This gave 3.6 g of a fine black powder.

| Elemental analysis | C | H | O | Si | Sn |
|---|---|---|---|---|---|
| Found | 52.9 | 1.1 | 20.0 | 15.4 | 7.0 |
| (% by weight) | | | | | |

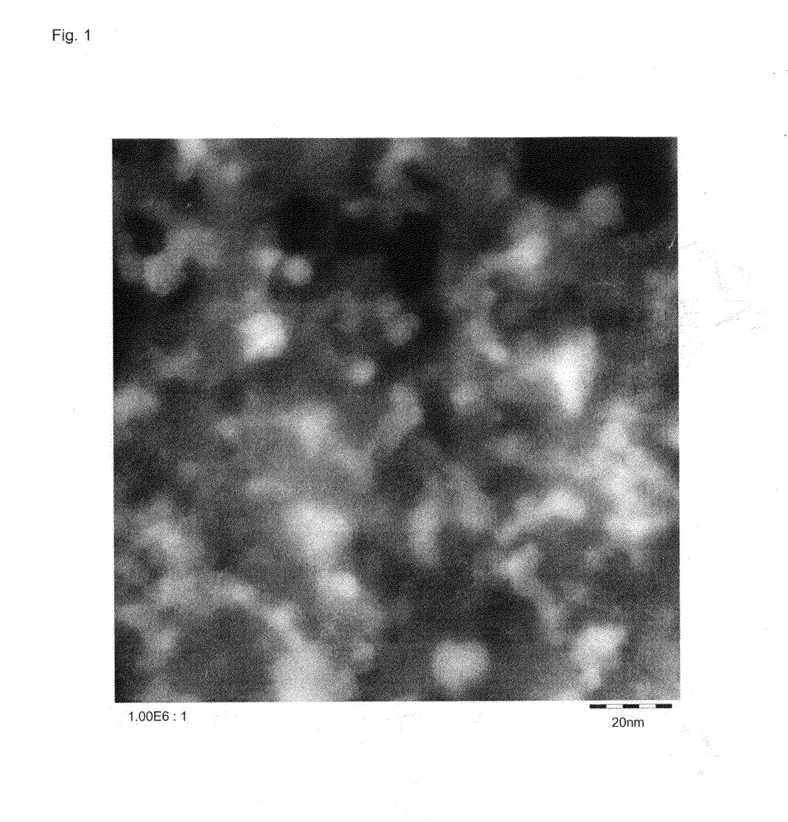

Samples of the electroactive material obtained were analyzed by means of TEM (see FIG. 1): The TEM studies were conducted as HAADF-STEM with a Tecnai F20 transmission electron microscope at a working voltage of 200 kV using ultrathin layer methodology (embedding of the samples into synthetic resin as a matrix). The light-colored sites are the heavier elements (Sn and Si here—(semi)metallic phase), the dark sites the carbon-rich elements (carbon phase), from which it is evident that the domain spacings are in the region of a few nm (not more than 10 nm).

### 1c) Production of an Electroactive Material (Lower Temperature)

6.2 g of composite material (K1.1) were heated in a tubular furnace with a quartz glass tube under hydrogen at a flow rate of 2-3 l/h. The oven was heated to 650° C. at 3-4° C./min and held at 650° C. for 2 h. Cooling was effected overnight under a nitrogen stream of 1-2 l/h.

This gave 3.7 g of a fine black powder.

| Elemental analysis | C | H | O | Si | Sn |
|---|---|---|---|---|---|
| Found | 53.0 | 1.7 | 20.8 | 15.0 | 7.0 |
| (% by weight) | | | | | |

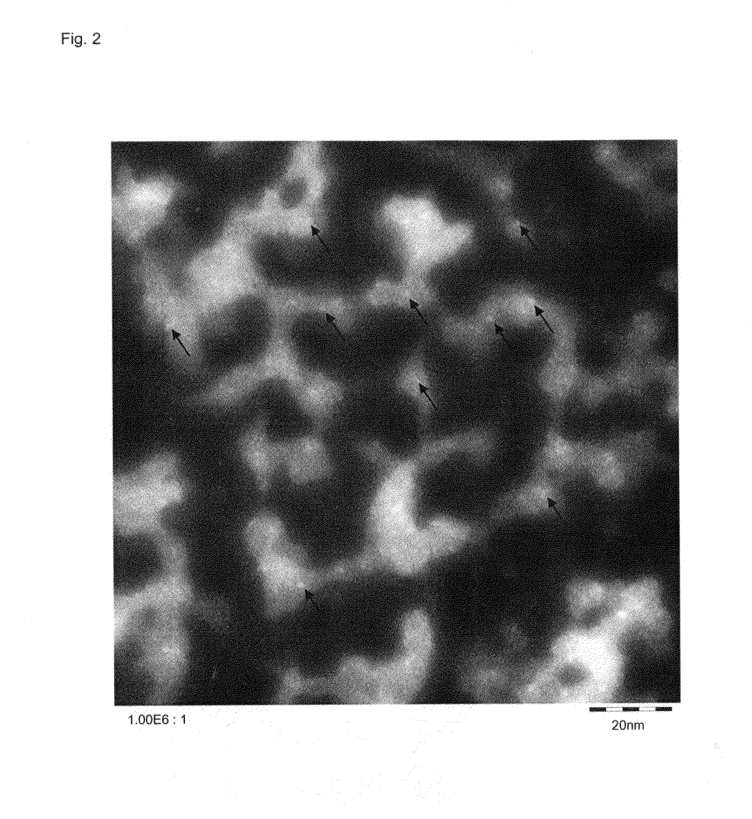

TEM image as shown in FIG. 2. The arrows indicate characteristic sites.

### 1d) Production of an Electrode

The electroactive material obtained in 1b) was subsequently mixed with conductive black (Super P Li from Timcal) and binder (polyvinylidene fluoride KYNAR FLEX® 2801) in order to obtain a viscous coating material consisting of 87% by weight of the electroactive material obtained in 1b), 6% by weight of conductive black and 7% by weight of binder in N-ethyl-2-pyrrolidone as solvent. The amount of solvent used was 125% by weight of the solids content used. For better homogenization, the coating material was stirred for 16 h. The coating material was subsequently applied to a copper film of thickness 20 μm (purity 99.9%) using a coating bar and dried at 120° C. under reduced pressure. After drying, the resulting electrodes (width 8 cm) were calendered with a linear pressure of 9 N/mm and then introduced into an argon atmosphere (water content <1 ppm, oxygen content <10 ppm). Before building the cell, the electrodes were dried once again at 5 mbar and 120° C. overnight. For the building of the electrochemical test cells (2-electrode test arrangement analogous to a button cell), circular pieces with a diameter of 20 mm were punched out. Lithium foil was used as the opposite electrode. The electrolyte used was 1 M LiPF₆ in a 1:1 mixture of ethylene carbonate and ethyl methyl carbonate. For electrochemical characterization, the cells were connected to a Maccor Series 4000 battery cycling unit. The cells were cycled at a specific current of 30 mA per gram of active material between 10 mV and 2 V against Li/Li⁺. After 10 mV had been attained, the voltage was kept constant for 30 min.

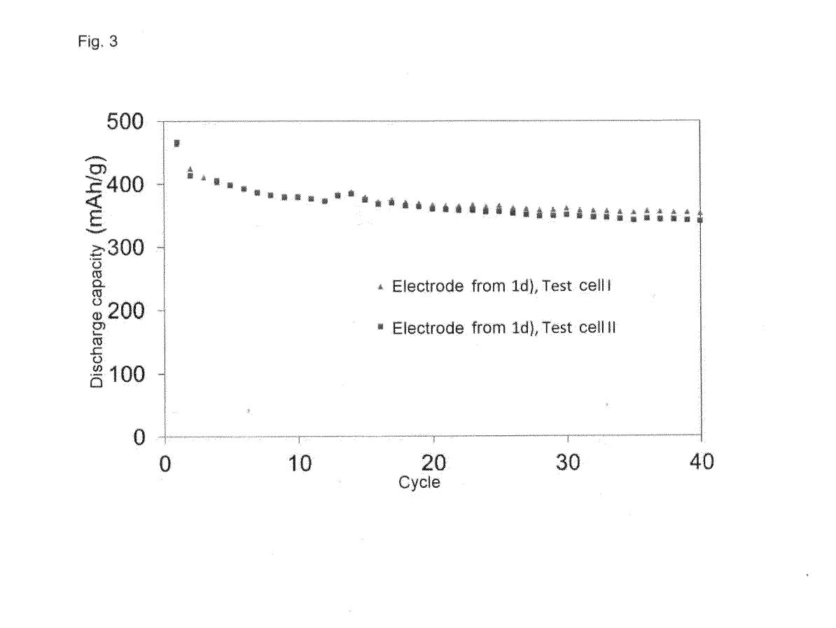

FIG. 3 shows the discharge capacity of two cells over 40 cycles. The capacity achieved is above values achievable for graphite. The virtually identical curve profile of the two cells makes clear the good reproducibility of the electrodes from 1d).

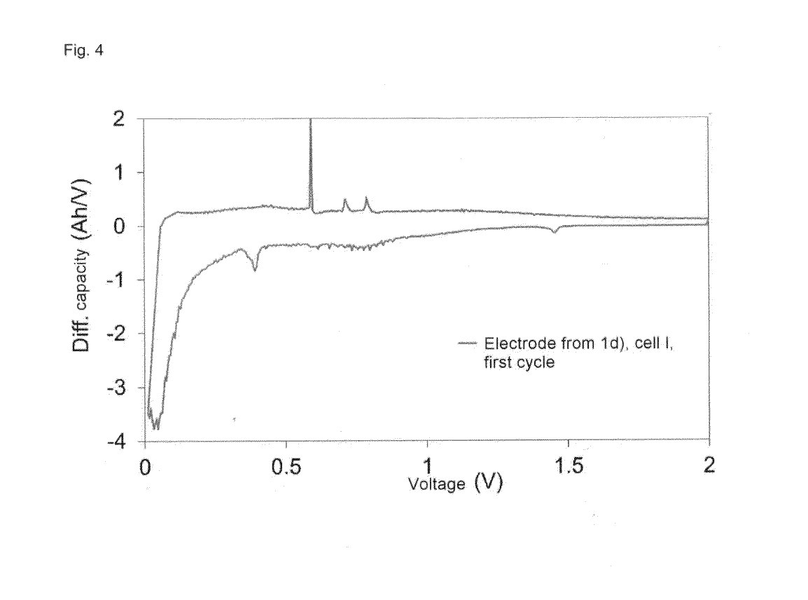

FIG. 4 shows the plot of differential capacity against the voltage. The values shown were calculated from the measured data from a chronoamperometry analysis. In chronoamperometry, a constant current is defined and the changes in the voltage are registered. The plot of the resulting differential capacity against voltage allows statements about characteristic electrochemical processes, for example incorporation or discharge of lithium, or decomposition of electrolyte. The characteristic peaks for electrochemical activity of tin at 0.4 V (incorporation or alloy formation of lithium with tin: negative y-axis) and between 0.6 and 0.8 volt (3 peaks for lithium extraction from lithium-tin alloy: positive y-axis) are clearly evident.

FIG. 4: Differential capacity of the electrode from 1d) at a voltage of 0 to 2 V.

### PRODUCTION EXAMPLE 2

### Production of a Composite Material (K1.2)

50 g of tetraphenoxysilane and 16.5 g of trioxane were initially charged and melted at 70° C. Then 13.45 g of CuCl₂ were dissolved in 100 ml of ethanol and homogenized with the melt. This solution was added dropwise to a mixture of 500 ml of toluene and 2.5 g of methanesulfonic acid at 100° C. A violet solid precipitated out, which was collected and washed with toluene and hexane. After drying, 40 g of a white powder were obtained. The powder was stirred with sodium hydrogencarbonate solution, filtered off with suction, washed with water and methanol and then dried.

Final weight: 46.7 g

| Elemental analysis | C | H | Si | Cu |
|---|---|---|---|---|
| Found | 56.4 | 4.5 | 6.0 | 6.0 |
| (% by weight) | | | | |

### PRODUCTION EXAMPLE 3

### 3a) Production of a Composite Material (K1.3)

25 g of tetraphenoxysilane, 8.25 g of trioxane and 13 g of tetraethoxysilane were melted. This solution was added dropwise to a mixture of 250 ml of xylene and 2.5 g of methanesulfonic acid at 100° C. A pink solid precipitated out, which was collected and washed with toluene and hexane, and then dried.

Final weight: 28 g

| Elemental analysis | C | H | Si | O |
|---|---|---|---|---|
| Found | 58.5 | 5.0 | 10.2 | 25.6 |
| (% by weight) | | | | |

### 3b) Production of an Electroactive Material (Lower Temperature)

3.9 g of composite material (K1.3) were heated in a tubular oven with a quartz glass tube under hydrogen at a flow rate of 2-3 l/h. The oven was heated to 800° C. at 3-4° C./min and held at 800° C. for 2 h. Cooling was effected overnight under a nitrogen flow of 1-2 l/h.

This gave 2.2 g of a fine black powder.

| Elemental analysis | C | H | O | Si |
|---|---|---|---|---|
| Found | 54.9 | 1.2 | 25.0 | 19.1 |
| (% by weight) | | | | |

### 3c) Production of an Electroactive Material (Higher Temperature)

3.8 g of composite material (K1.3) were heated in a tubular oven with a quartz glass tube under hydrogen at a flow rate of 2-3 l/h. The oven was heated to 980° C. at 3-4° C./min and held at 980° C. for 2 h. Cooling was effected overnight under a nitrogen flow of 1-2 l/h.

This gave 2.1 g of a fine black powder.

| Elemental analysis | C | H | O | Si |
|---|---|---|---|---|
| Found | 55.6 | 0.7 | 24.0 | 19.6 |
| (% by weight) | | | | |

1: A process for producing a composite material comprising
a) a (semi)metallic phase and
b) an organic polymer phase,
the process comprising copolymerizing
compound I, which is at least one compound selected from the group consisting of an aryloxy (semi)metallate and an aryloxy ester of a nonmetal which forms an oxo acid, the nonmetal being different than carbon and nitrogen, with
compound II, which is at least one compound selected from the group consisting of a ketone, formaldehyde and a formaldehyde equivalent
in the presence of
compound III, which is at least one (semi)metal compound which is not an aryloxy (semi)metallate,
to obtain a copolymer,
where a weight of (semi)metal in compound III is at least 5% by weight based on a weight of compound I.

2: The process of claim 1, wherein compound III is dissolved in a reaction medium.

3: The process of claim 1, wherein compound III is added to a melt of compounds I and II.

4: The process of claim 1, wherein compound III comprises at least one (semi)metal selected from the group consisting of Ti, Fe, Co, Cu, Si and Sn.

5: The process of claim 1, wherein compound III is at least one compound selected from the group consisting of Fe(CH₃COO)₂, CoCl₂, CuCl₂, SnCl₂, FeCl₃, Si(OCH₃)₄, TiCl₄ and SnCl₄.

6: The process of claim 1, wherein compound I has a formula I:
[(AryO)ₘMOₙRₚ]_{q} (I)
in which
M is a (semi)metal or a nonmetal other than carbon and nitrogen which forms an oxo acid,
m is 1, 2, 3, 4, 5 or 6,
n is 0, 1 or 2,
p is 0, 1, 2 or 3,
q is an integer from 1 to 20,
m+2n+p is 1, 2, 3, 4, 5 or 6 and corresponds to a valency of M,
Ary is phenyl or naphthyl, where a phenyl ring or a naphthyl ring is unsubstituted or may have one or more substituents selected from the group consisting of alkyl, cycloalkyl, alkoxy, cycloalkoxy and NRₐR_{b}, in which Rₐ and R_{b} are each independently hydrogen, alkyl or cycloalkyl,
R is hydrogen, alkyl, alkenyl, cycloalkyl or aryl, where aryl is unsubstituted or may have one or more substituents selected from alkyl, cycloalkyl, alkoxy, cycloalkoxy and NRₐR_{b}.

7: The process of claim 1, wherein the copolymer obtained is heated.

8: The process of claim 1, wherein an oxidizing or reducing agent is allowed to act on the copolymer obtained.

9: A composite material comprising
a) a (semi)metallic phase and
b) an organic polymer phase,
wherein at least one (semi)metallic phase comprises at least two different (semi)metals, a weight of each (semi)metal in the composite material is at least 2% by weight based on a weight of carbon in the composite material, at least one organic polymer phase forms phase domains with at least one (semi)metallic phase, and an average distance, defined as an arithmetic mean of distances between two adjacent domains of identical phases, determined by small-angle X-ray scattering, is essentially not more than 200 nm.

10: A composite material comprising
a) a carbon phase and
b) at least one phase selected from the group consisting of an oxidic phase and a (semi)metallic phase which comprises at least two different (semi)metals,
wherein a weight of each (semi)metal in the composite material is at least 2% by weight based on a weight of carbon in the composite material, at least one oxidic phase or (semi)metallic phase and at least one carbon phase form phase domains, and (i), (ii), or both (i) and (ii), where:
(i) an average distance, defined as an arithmetic mean of distances between two adjacent domains of identical phases, determined by small-angle X-ray scattering, is essentially not more than 10 nm, and
(ii) the oxidic phase, the (semi)metallic phase, or both phases, forms essentially phase domains with an average diameter, defined as an arithmetic mean of diameters of not more than 20 μm, determined by small-angle X-ray scattering.

11: (canceled)

12: An electrode comprising the composite material of claim 10.

13: An electrochemical cell comprising the electrode of claim 12.

14: (canceled)

15: A lithium ion battery comprising the electrochemical cell of claim 13.

16: (canceled)

17: A device comprising the electrochemical cell of claim 13.

18: The process of claim 1, wherein compound I comprises the aryloxy (semi)metallate.

19: The process of claim 1, wherein compound I comprises the aryloxy ester of a nonmetal.

20: The process of claim 1, wherein compound II comprises the ketone.

21: The process of claim 1, wherein compound II comprises formaldehyde.

22: The process of claim 1, wherein compound II comprises the formaldehyde equivalent.

23: The process of claim 2, wherein compound III is added to a melt of compounds I and II.
